(19) United States
(12) Patent Application Publication
(10) Pub. No.: US 2008/0282856 A1
(43) Pub. Date: Nov. 20, 2008

(54) Method for cutting wooden venetian blinds and relative cutting machine

(75) Inventor: Emilio Antonini, Trieste (IT)

Correspondence Address: HAMRE, SCHUMANN, MUELLER & LARSON, P.C., P.O. BOX 2902, MINNEAPOLIS, MN, 55402-0902, US

(73) Assignee: YEO LONG Srl, Trieste (IT)

(21) Appl. No.: 12/152,236

(22) Filed: May 13, 2008

(30) Foreign Application Priority Data
May 14, 2007 (IT) UD2007A000083

(51) Int. Cl. B26D 3/00; B26D 7/06

(52) U.S. Cl. 83/35; 83/39; 83/437.2

(57) ABSTRACT

A cutting method for cutting to size a wooden Venetian blind, already at least partly assembled, in a cutting machine, comprises a first step in which the wooden Venetian blind and a first cutting unit of the cutting machine, provided with first cutting means able to cut the metal container of the wooden Venetian blind, are brought into proximity by means of a first movement unit of the cutting machine, a second step in which the metal container is cut by means of the first cutting unit, and a third step in which the first cutting unit and the wooden Venetian blind are distanced from each other by means of the first movement unit, a fourth step in which the wooden Venetian blind and a second cutting unit of the cutting machine, provided with second cutting means able to cut the wooden slats of the wooden Venetian blind, are brought into proximity by means of a second movement unit of the cutting machine and a fifth step in which the wooden slats are cut by means of the second cutting unit.

### FIELD OF THE INVENTION

The present invention concerns a method for cutting to size, with regard to the width, a wooden Venetian blind, already at least partly assembled, and the relative cutting machine.

### BACKGROUND OF THE INVENTION

Wooden Venetian blinds are known, which are disposed to cover an aperture made on a wall. The blinds normally comprise a plurality of wooden slats, a metal container, disposed above the slats and able to be attached to an upper edge of the aperture, and a wooden counter-weight disposed below the slats. Inside the metal container a movement mechanism is housed for the slats, which normally comprises two adjustment cords, disposed symmetrically with respect to a median axis of the blind, which pass inside corresponding through holes made on each of the slats.

The adjustment cords allow to pack or extend the slats and the counter-weight, and also to direct the slats in a plurality of angles, so as to regulate the passage of light.

To reduce the production costs of such blinds, producers have tried, in recent years, to adopt solutions intended to standardize as much as possible the production of at least some of the components. Therefore, they produce pre-assembled blinds, in which the final measurements are obtained starting from a blind that is already almost complete and is of a standard measurement.

Obtaining the final measurements is delegated to a body of the intermediate distribution chain, for example a store or suchlike, or even the final client. It is therefore necessary to render the cutting operations easy and quick, at the same time obtaining a quality result which can be used immediately by the final client. Usually, to make the metal container it is typical to use a material such as for example aluminum which, apart from the mechanical and aesthetic characteristics required by the function of the container, is also compatible, from the viewpoint of cutting characteristics, with the wood of which the slats of the blinds are made.

The producers of blinds, for economic reasons, have tried to use less costly materials for the metal container, for example steel.

This tendency, however, causes problems in the cutting step, since the type of blade, and its use, to cut the wood correctly, is different from that used to cut steel, because for example the material, the number of teeth and the speed of rotation are different.

If, on the one hand, therefore, a saving is obtained in terms of material, on the other hand an unsustainable burden is caused in production, since the pre-assembled blind can no longer be trimmed in width in a single pass and on the same machine, or it can be done only at the cost of an unacceptable deterioration in quality.

Purpose of the present invention is to perfect a method, and achieve a relative machine, which allow to cut to size the already assembled wooden Venetian blinds provided with a container made of ferrous material, in a simple, quick, precise and uniform manner.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

A cutting method according to the present invention can be used to cut to size, with regards to width, a wooden Venetian blind, already at least partly assembled, and comprising at least a plurality of wooden slats and a metal container for a movement mechanism of the slats, in a cutting machine having a work plane on which the wooden Venetian blind is able to be positioned and moved. By the expression “at least partly assembled”, we mean that the blind has the metal container and the wooden slats reciprocally connected, by means of the relative movement mechanism.

According to a characteristic feature of the present invention, the method comprises the following steps:
a first step in which the wooden Venetian blind and a first cutting unit of the cutting machine, provided with first cutting means of the type suitable to cut the metal container, are brought close to each other by means of a first movement unit of the cutting machine;
a second step in which the metal container is cut in width by means of said first cutting unit;
a third step in which the first cutting unit and the wooden blind are distanced from each other by means of the first movement unit;
a fourth step in which the wooden Venetian blind and a second cutting unit of said cutting machine, provided with second cutting means suitable to cut the wooden slats, are brought close to each other by means of a second movement unit of the cutting machine; and
a fifth step in which the slats are cut by means of the second cutting unit.

By means of the method according to the present invention and the relative cutting machine, it is possible to cut to size the wooden Venetian blinds already assembled and provided with a container made of ferrous material, for example steel or suchlike, simply, quickly, precisely and uniformly, also obtaining uniform cutting characteristics both for the wooden slats and also for the container made of ferrous material. This allows to make a final product of optimum quality, with an economic saving of about 7%-9%, due to the use of the ferrous material, and also due to the efficacy of the cutting method and machine according to the present invention.

This is possible because the cutting of the container and the slats is done with different and dedicated cutting units, suitably selecting the characteristics of the cutting units, and in particular of their cutting means.

Also the fact that the relative displacements of the first cutting unit and the wooden Venetian blind, and of the wooden Venetian blind and the second cutting unit, occur in a distinct manner, contributes to a greater efficacy of the cutting operation.

In particular, the present invention benefits from the fact that, generally, the metal container of the blind has transverse sizes (height and depth) which are less than the diameter of the blades normally used as cutting means, and therefore a movement of the blades in a direction transverse to the disposition of the blind, that is, to the plane on which the blind lies, is sufficient to cut the container, whereas the length of the packed blind is in any case normally greater than the diameter of the blades, and therefore, in this case, a movement of the blind towards the cutting blade, held still, is sufficient, in order to cut to size the slats in the direction of their width.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a plane view of a cutting machine according to the present invention;

FIG. 2 is a plane view of a cutting machine according to the present invention in a first position of initial cutting;

FIG. 3 is a plane view of a cutting machine according to the present invention in a second cutting position;

FIG. 4 is a plane view of a cutting machine according to the present invention in a third cutting position;

FIG. 5 is a plane view of a cutting machine according to the present invention in a fourth cutting position;

FIGS. 6 to 12 are schematic lateral views in sequence of the cutting machine according to the present invention in different cutting positions;

FIG. 13 is a schematic view of a part of the machine according to the present invention; and

FIG. 14 is a perspective view of a wooden Venetian blind.

### DETAILED DESCRIPTION OF A PREFERENTIAL FORM OF EMBODIMENT

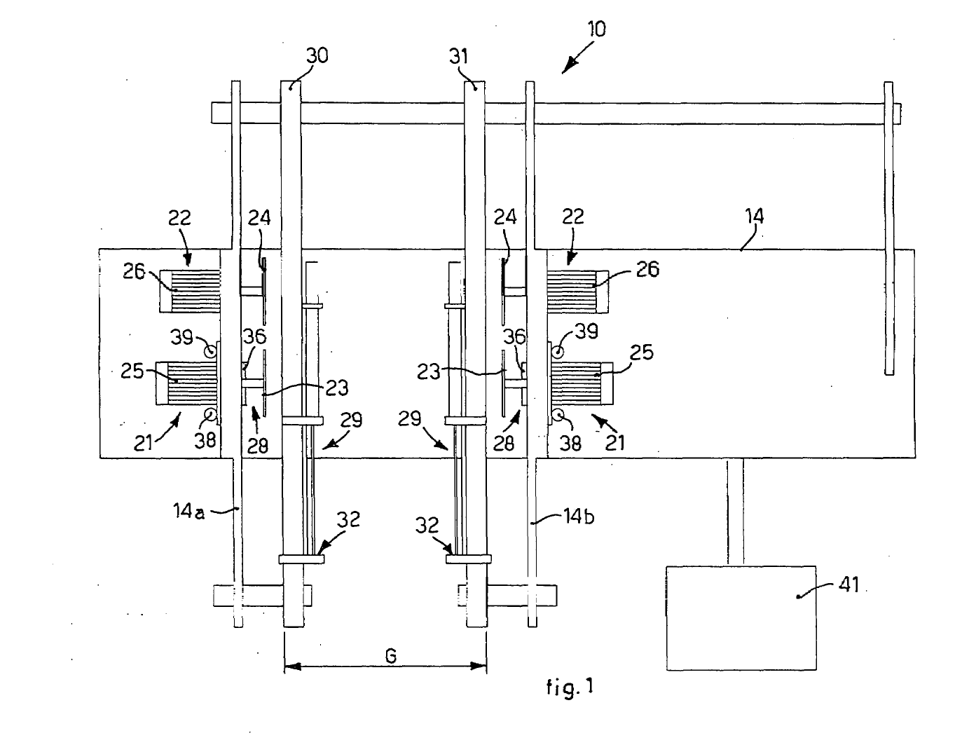

With reference to FIG. 1, a machine 10 according to the present invention can be used to take to a desired measurement in width “a” (FIG. 5) an already assembled wooden Venetian blind 11, of the type applied to an aperture made in a wall.

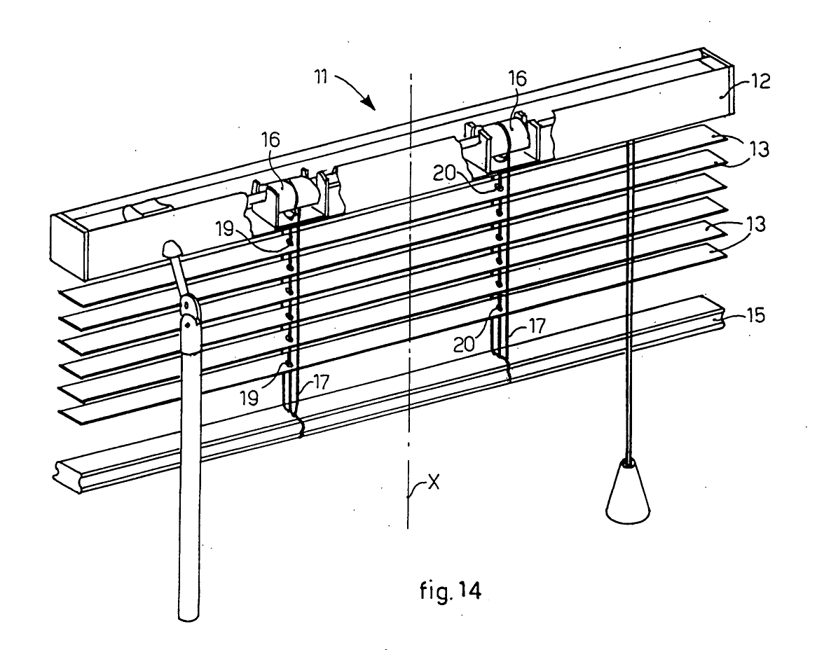

In particular, the wooden Venetian blind 11 (FIG. 14) is provided already assembled to a retailer and in a finished series of standardized measurements, and must be taken to the final value required by the user by trimming the width. It comprises, in this case, a container 12 made of ferrous material, for example steel or suchlike, a plurality of wooden slats 13, a counter-weight 15, also made of wood, and a movement mechanism 16 disposed at least partly inside the container 12, which, during use, allows to selectively lift/lower the counter-weight 15 and the slats 13, and to direct in a desired manner the angle of the latter so as to regulate the passage of light.

The movement mechanism 16 comprises in this case two adjustment cords 17, disposed symmetrically with respect to a median axis “x” of the blind 11 and connected to each of the slats 13 and the counter-weight 15.

The container 12 has a substantially U-shaped cross section, so as to allow to contain the movement mechanism 16, and is able to be attached, during use, to the upper edge of the aperture on which the blind 11 is applied.

Each slat 13 has a first through hole 19 and a second through hole 20 made symmetrically to the median axis “x” and in each of which one of the two adjustment cords 17 is made to pass.

The cutting machine 10 (FIGS. 1, 2, 3, 4 and 5) comprises a supporting frame 14, having two lateral walls 14a and 14b, parallel to each other and on each of which, in specular fashion, a first cutting unit 21 and a second cutting unit 22 are mounted. The first cutting unit 21 is to cut the metal container 12, and the second cutting unit 22 is to cut the wooden slats 13 and is disposed downstream of the first cutting unit 21. The cutting units 21 and 22 are provided with respective cutting blades 23 and 24, selectively made to rotate by suitable motors 25 and 26. In particular the cutting blade 23 of the first cutting unit 21 is of a first type able to efficaciously cut a ferrous material, such as steel, whereas the second blade 24 is of a second type able to cut wood or similar material with a cellulose base.

Furthermore, the supporting frame 14 supports two horizontal sliding guides 30, 31, along which the blind 11 is moved so as to pass from the cutting units 21 to the cutting units 22, during the various steps of the cutting to size.

The two guides 30 and 31 are mounted substantially parallel to each other, so that the relative blades 23 and 24, mounted on the respective cutting units 21 and 22, are also substantially parallel to each other, in order to guarantee that the cut to be made is parallel. The reciprocal distance “G” between the external edges of the guides 30, 31 is less than the width of the blind 11 before it is cut, and is predefined so that the protruding parts of the blind 11, which exceed the measurement “a”, are at least partly cut and constitute the final discard.

Moreover, at least the blades 23 and 24 are disposed symmetrically and external with respect to the relative guides 30 and 31, that is, at a distance, between them, greater than the distance “G”.

Each cutting unit 21, and in particular its blade 23, in the inactive position is below the guides 30 and 31, whereas each cutting unit 22, and in particular its blade 24, is above the guides 30 and 31, as can be seen in FIG. 6.

The machine 10, in correspondence with both its lateral walls 14a and 14b, is provided with a first movement unit 28, which is able to move vertically and selectively the respective first cutting unit 21, which can therefore pass from the inactive position to a cutting position, in which the blade 23 protrudes by a determinate distance beyond the guides 30 and 31, so as to cut the metal container 12.

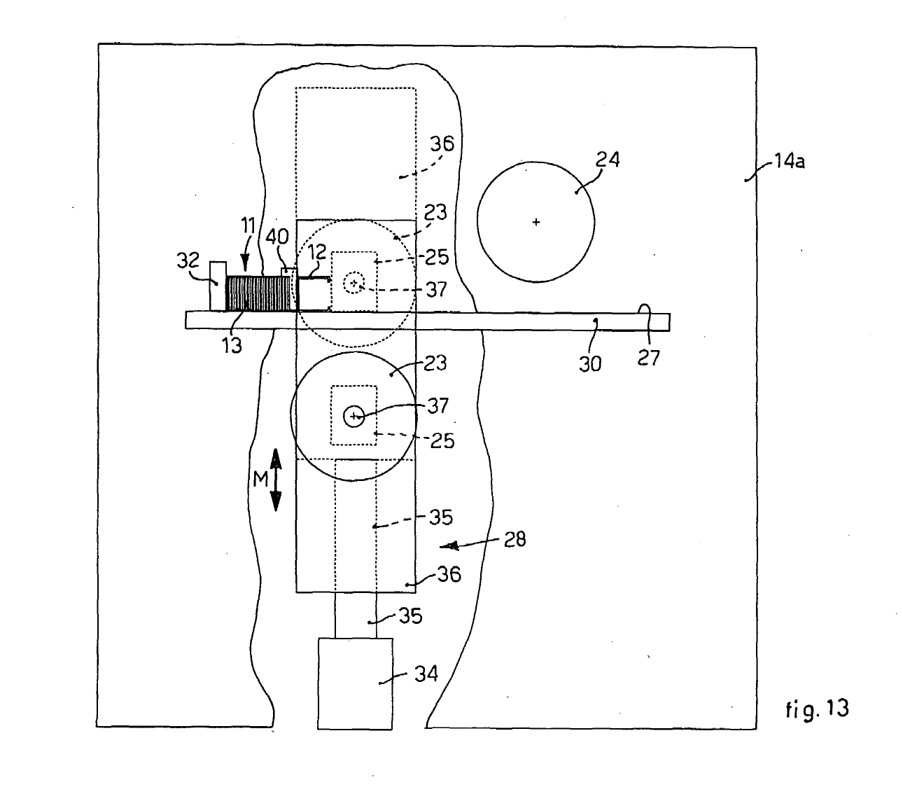

FIG. 13 shows a schematic view of a non-restrictive embodiment of the first movement unit 28, according to the present invention.

In particular, FIG. 13 shows with a continuous line the configuration of the machine 10 in the inactive position, and with a line of dashes the configuration of the machine 10 in a position for cutting the metal container 12.

In the embodiment shown in FIG. 13, the movement unit 28 comprises a device with a cylinder 34 and piston 35, actuated alternately in a vertical manner by means of actuator members, for example fluid-dynamic or electronic, of a known type and not shown in the drawings. The piston 35 is solid, at one end, with a slider 36 on which a transmission shaft 37 is rotatably supported, which is made to rotate by the respective motor 25. The slider 36 is mounted associated with an eyelet, not shown in the drawings, on the respective lateral walls 14a, 14b of the supporting frame 14, and is free to move vertically thanks to the action of the piston 35, drawing with it the transmission shaft 37 and the relative motor 25. The latter is further guided in its vertical movement by two vertical guides 38, 39, located on the external side of the respective lateral walls 14a, 14b.

The cutting blade 23 is keyed onto the transmission shaft 37 and therefore not only rotates on itself so as to cut the container 12 of the blind 11, but can also move vertically, following the alternate vertical movement of the slider 36, as indicated by the arrow M in FIG. 13.

The machine 10, in correspondence with each guide 30, 31, is also provided with a second movement unit 29, which is able to move the blind 11 horizontally along the guides 30, 31, taking it from the first cutting unit 21 to the second cutting unit 22.

The two movement units 29, in correspondence with the guides 30, 31, define a substantially horizontal work plane 27, on which the wooden Venetian blind 11 to be cut is rested. Furthermore, each of the two movement units 29 is provided with a slider 32, sliding along the respective guide 30 and 31. Each slider 32, by means of suitable clamping elements, of a known type and not shown in the drawings, at the beginning of the cutting operation is made selectively solid with the blind 11, so that it can move it. Each movement unit 29 is also provided with vertical, horizontal and lateral presser devices, for example of the type described in the application for an industrial invention UD2004A000234 filed in the name of the present Applicant and not shown in the drawings, in order to correctly rest, pack and align the blind 11 on the work plane 27, and with motor means, also of a known type and not shown in the drawings, to drive the sliders 32 and the presser devices.

The cutting machine 10 also comprises a command and control unit 41, shown for convenience in FIG. 1 only, which coordinates the functioning of the two cutting units 21, the two cutting units 22, the two movement units 28 and the two movement units 29.

In particular, the sliding of the sliders 32 on the relative guides 30 and 31 is activated by means of actuator members, for example fluid-dynamic or electronic, of a substantially known type, not shown in the drawings and commanded automatically by the command and control unit 41.

The method according to the present invention to cut the wooden Venetian blind 11 is as follows.

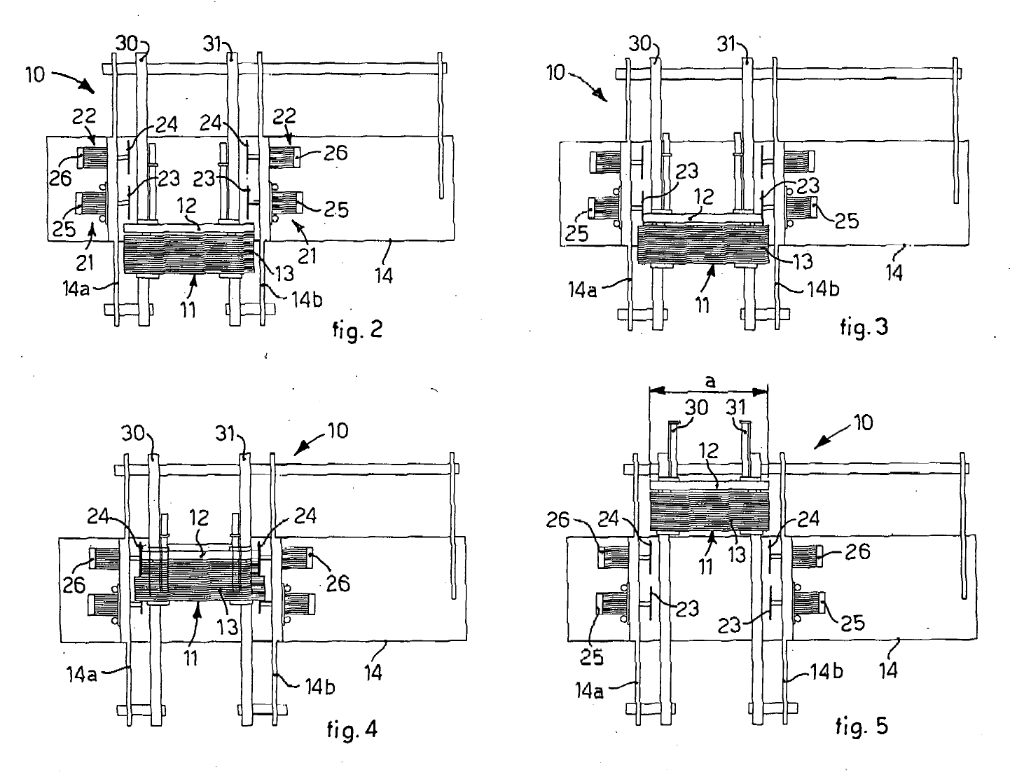

Firstly, in a preliminary step of the cutting operation, the blind 11 is positioned on the work plane 27, with the container 12 facing towards the first cutting unit 21, and in the packed configuration, that is, with the slats 13 in contact with each other and adjacent to the container 12. In this way, we determine a determinate position of initial cutting, which depends on the final measurement “a” to which the wooden Venetian blind 11 must be taken and on its initial measurement, as can be seen in FIGS. 2 and 6. The adjustment of the initial position is effected by means of said presser devices, in a known manner, for example as disclosed by said application for a patent of industrial invention UD2004A000234.

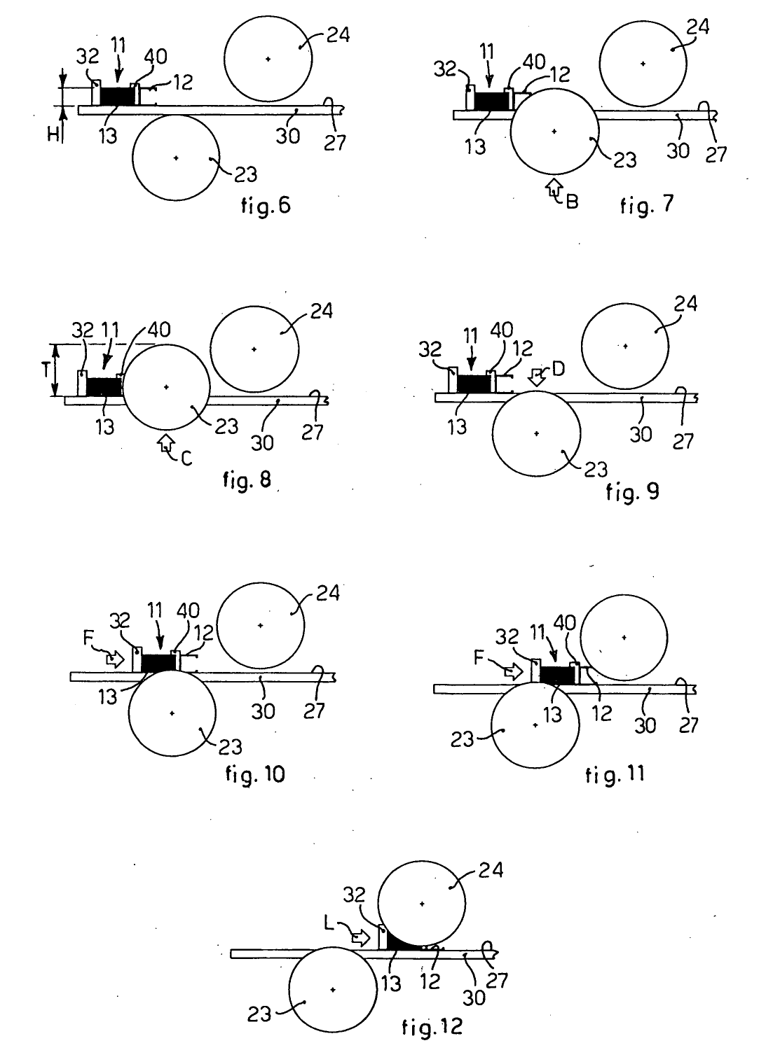

In a first cutting step, the blade 23 of the first cutting unit 21, made to rotate at a suitable number of revolutions, is raised, as indicated by the arrow B in FIG. 7, by driving the device with the cylinder 34 and piston 35, beyond the work plane 27, passing from the condition shown in FIG. 6 to the condition shown in FIG. 7.

In a second cutting step, the rotating blade 23, coming into contact with the container 12, continues its vertical travel, as indicated by the arrow C in FIG. 8, to effect the actual cut of the container 12 (FIGS. 3, 7 and 8). Therefore, with the height of the container 12 as “H” (FIG. 6), in order to complete the cut of the container 12, with the blade 23 initially under the work plane 27, the overall vertical lifting of the blade 23 above the work plane 27, is equal to a distance “T”, which is greater than said height “H” of the container 12.

A third cutting step provides that, once the container 12 has been correctly cut, each movement unit 29 determines the vertical lowering, as indicated by the arrow D in FIG. 9, of the respective blade 23 by a predetermined distance (FIG. 9).

The entity of the lowered distance can be greater than said distance “T”, so that the blade 23 is positioned completely below the work plane 27, so not interfering with the blind 11, and in particular with the slats 13, which are subsequently displaced along the guides 30, 31.

Alternately, said lowered distance is slightly less than the distance “T”, so that, when it is completely lowered, the blade 23 protrudes slightly beyond the work plane 27 and, continuing to rotate, functions as an incisor of the slats 13 which, subsequently, are made to advance along the guides 30, 31. This situation is shown, in particular, in FIGS. 9, 10 and 11. This is possible because the blade 23, although it is suitable to cut a ferrous material effectively, also operates correctly as a wood cutter.

After distancing the blade 23 from the blind 11, in a fourth cutting step the sliders 32 make the blind 11 advance, as indicated by the arrow F in FIGS. 10 and 11, towards each second cutting unit 22, along the guides 30 and 31 (FIGS. 10 and 11). The entity of this advance is predetermined according to the interaxis between the two blades 23 and 24, and also according to the overall length of the blind 11 when it is packed. As we said, in this advancing step, the blade 23 can make a rectilinear incision on the lower surface of the slats 13, so that the corresponding blade 24 makes a clean cut of the excess parts with respect to the measurement “a” to which the blind 11 is to be taken (FIGS. 9, 10 and 11). In this case, it is clear that the incision operation is a part of, or is preparatory to, the subsequent cutting step proper of the slats 13.

The blade 24 of the second cutting unit 22 is in a fixed position above the work plane 27, at a predetermined distance from the work plane 27 and external to the respective guide 30, 31, so as to allow the correct cutting to size “a” of the slats 13. Following the advance of the blind 11, as indicated by the arrow L in FIG. 12, in a fifth cutting step, the slats 13 come into contact with the rotating blade 24 and the cutting to size “a” of the slats 13 is finally carried out correctly (FIGS. 4 and 12). Subsequently, the blind 11, having the desired final sizes, as can clearly be seen in FIG. 5, is made available for further finishing operations.

According to an advantageous solution of the present invention, in cooperation with the sliders 32 spacer elements 40 are provided which, in said preliminary cutting step, are disposed between the container 12 and the slats 13, and which maintain the container 12 adequately distanced, so that the blade 23 only cuts the container 12. Furthermore, the spacers 40, cooperating with the respective sliders 32 and with the presser devices, contribute to maintaining the blind 11 packed during the various steps of the cutting to size.

The above-mentioned application for a patent of industrial invention UD2004A000234 amply describes the methods for adjusting the distance between the guides, the position of the cutting units and the blind itself on the work plane, which can be used in the present invention to obtain the cutting to size “a” and which therefore will not be described here.

As a whole, the method according to the present invention is advantageously controlled automatically by means of the command and control unit 41.

It is clear that modifications and/or additions of parts and/or steps may be made to the cutting machine and the relative method as described heretofore, without departing from the field and scope of the present invention.

For example, the relative movements of the blind 11 and the first cutting unit 21 and of the blind 11 and the second cutting unit 22 can be modified and/or inverted, providing that the blind 11 moves and the second cutting unit 22 remains still when the container 12 is being cut, and/or the blind 11 is still and the second cutting unit 22 moves when the slats 13 are being cut, or that the slats 13 are cut before the container 12, or a combination of these reciprocal movements.

It is also clear that, although the present invention has been described with reference to some specific examples, a person of skill in the art shall certainly be able to achieve many other equivalent forms of cutting machine and relative cutting method, having the characteristics as set forth in the claims and hence all coming within the field of protection defined thereby.

1. A cutting method for cutting to size a wooden Venetian blind, already at least partly assembled, in a cutting machine, said wooden Venetian blind comprising at least a plurality of wooden slats and a metal container for a movement mechanism of said slats, said cutting machine comprising a work plane on which said wooden Venetian blind is able to be positioned and moved, the cutting method comprising the following steps:
a first step in which said wooden Venetian blind and a first cutting unit of said cutting machine, provided with first cutting means of a type able to cut said metal container, are brought into proximity by means of a first movement unit of said cutting machine;
a second step in which said metal container is cut by means of said first cutting unit;
a third step in which said first cutting unit and said wooden Venetian blind are distanced from each other by means of said first movement unit;
a fourth step in which said wooden Venetian blind and a second cutting unit of said cutting machine, provided with second cutting means of a type able to cut said wooden slats, are brought into proximity by means of a second movement unit of said cutting machine;
a fifth step in which said wooden slats are cut by means of said second cutting unit.

2. A cutting method as in claim 1, wherein, at least in said first step and in said third step, said first cutting means is able to be moved orthogonally with respect to said work plane.

3. A cutting method as in claim 1, wherein, at least in said fourth step, said wooden Venetian blind is able to be moved parallel with respect to said work plane.

4. A cutting method as in claim 2, wherein, in said first step and in said third step, said wooden Venetian blind is stationary on said work plane and said first cutting means is moved vertically, respectively towards and away from said metal container of said wooden Venetian blind.

5. A cutting method as in claim 2, wherein, in said first step, said first cutting means is initially positioned below said work plane.

6. A cutting method as in claim 2, wherein, in said first step, said first cutting means is moved at least by a distance (T), with respect to said work plane, equal to the height (H) of said metal container.

7. A cutting method as in claim 4, wherein in said second step too, said first cutting means is moved vertically, in order to take said first cutting means into contact with said metal container and to cut said metal container.

8. A cutting method as in claim 4, wherein, in said third step, the vertical displacement of said first cutting means is equal to at least a predetermined distance with respect to said work plane, such that in said fourth step said first cutting means does not interfere with said wooden slats.

9. A cutting method as in claim 4, wherein, in said third step, the vertical displacement of said first cutting means is equal to at least a predetermined distance with respect to said work plane, such that in said fourth step said first cutting means protrudes slightly from said work plane so as to interfere with said wooden slats and also to make a rectilinear incision on said wooden slats.

10. A cutting method as in claim 3, wherein, in said fourth step, said second cutting means is stationary with respect to said work plane, and said wooden Venetian blind is moved horizontally along said work plane towards said second cutting means.

11. A cutting method as in claim 10, wherein, in said fifth step, said wooden Venetian blind is moved horizontally so as to take said second cutting means into contact with said slats and to cut said wooden slats.

12. A cutting method as in claim 1, wherein, in a preliminary cutting step, before said first step, a spacer means is positioned between said metal container and said wooden slats so as to prevent contact, in said first step and said second step, between said first cutting means and said wooden slats.

13. A cutting method as in claim 1, wherein said metal container is of ferrous material.

14. A cutting method as in claim 1, wherein said first cutting means is able to cut a ferrous material.

15. A cutting machine for cutting to size a wooden Venetian blind, already at least partly assembled, said wooden Venetian blind comprising at least a plurality of wooden slats and a metal container for a movement mechanism of said wooden slats, the cutting machine comprising:
at least a first cutting unit of a first type able to cut said metal container and at least a second cutting unit of a second type able to cut said wooden slats; and
a first movement unit able to selectively bring closer and distance said first cutting unit and said wooden Venetian blind and a second movement unit able to selectively bring closer said wooden Venetian blind and said second cutting unit.

16. A cutting machine as in claim 15, wherein said first cutting unit is also able to function as an incisor means for said wooden slats in the cutting step of the wooden slats.

17. A cutting machine as in claim 15, comprising two horizontal guides which define a work plane on which said wooden Venetian blind is able to be positioned and moved during the cutting operation.

18. A cutting machine as in claim 17, wherein said first cutting unit and said second cutting unit are disposed in sequence along said guides.

19. A cutting machine as in claim 18, wherein said second cutting unit is disposed downstream of said first cutting unit with respect to a direction of advance of said wooden Venetian blind during the cutting operation.

20. A cutting machine as in claim 15, comprising spacer means able to be positioned between said metal container and said wooden slats at least during the cutting of said metal container.
